(19) United States
(12) Patent Application Publication
(10) Pub. No.: US 2018/0208041 A1
(43) Pub. Date: Jul. 26, 2018

(54) VEHICLE DRIVE DEVICE

(71) Applicant: AISIN AW CO., LTD., Anjo-shi, Aichi-ken (JP)

(72) Inventor: Takahisa HIRANO, Anjo (JP)

(73) Assignee: AISIN AW CO., LTD., Anjo-shi, Aichi-ken (JP)

(21) Appl. No.: 15/744,739

(22) PCT Filed: Sep. 5, 2016
(86) PCT No.: PCT/JP2016/075962

§ 371 Date: Jan. 12, 2018

(30) Foreign Application Priority Data
Sep. 18, 2015 (JP) 2015-185343

(51) Int. Cl. B60K 6/383; B60K 6/387; B60K 6/445; F16D 25/0638

(52) U.S. Cl. CPC B60K 6/383; B60K 6/387; F16D 41/07; F16D 25/0638; B60K 6/445

(57) ABSTRACT

A vehicle drive device that includes an input member drivingly coupled to an internal combustion engine; an output member drivingly coupled to wheels; a first rotating electric machine; a second rotating electric machine drivingly coupled to the output member; a differential gear device having three rotating elements, namely a first rotating element, a second rotating element, and a third rotating element, in order of rotational speed; and a friction engagement first clutch that is located in a power transmission path connecting the input member to the differential gear device and that allows the input member and the differential gear device to be decoupled from each other.

### BACKGROUND

The present disclosure relates to a vehicle drive device.

A vehicle drive device described in Japanese Patent Application Publication No. 2010-36880 (JP 2010-36880 A) is known. Hereinafter, in this “BACKGROUND ART” section, characters in brackets [ ] are cited from JP 2010-36880 A for the purpose of description. The vehicle drive device disclosed in JP 2010-36880 A includes the following: an input member [I] drivingly coupled to an internal combustion engine [E]; an output member [O] drivingly coupled to wheels [W]; a first rotating electric machine [MG1]; a second rotating electric machine [MG2] drivingly coupled to the output member; and a differential gear device [P1] having three rotating elements, namely a first rotating element [s1], a second rotating element [cal], and a third rotating element [r1], in order of arrangement in a speed diagram (in order of rotational speed). According to the structure described in JP 2010-36880 A, the first rotating electric machine is drivingly coupled to the first rotating element, the input member is drivingly coupled to the second rotating element, and the output member is drivingly coupled to the third rotating element. In other words, according to the structure disclosed in JP 2010-36880 A, the second rotating element is an input rotating element to which the input member is drivingly coupled, and the third rotating element is an output rotating element to which the output member is drivingly coupled.

An aspect illustrated in FIG. 10 of JP 2010-36880 A includes a dog clutch [DC1] that allows the input member and the differential gear device to be decoupled from each other, and a one-way clutch [OC1] that restricts rotation of the input rotating element (the second rotating element) to one direction. The one-way clutch makes it possible that when the internal combustion engine is stopped, the input rotating element (the second rotating element) rotationally restricted by the one-way clutch receives a reaction force of torque of the first rotating electric machine transmitted to the first rotating element, thus allowing the torque of the first rotating electric machine to be transmitted to the output member via the output rotating element (the third rotating element). Specifically, as an electric travel mode that transmits torque of only a rotating electric machine to an output member in order to cause a vehicle to travel, the aspect illustrated in FIG. 10 of JP 2010-36880 A can achieve not only a first electric travel mode (the second EV mode in JP 2010-36880 A) that transmits torque of only the second rotating electric machine to the output member, but also a second electric travel mode (the first EV mode in JP 2010-36880 A) that transmits, to the output member, torque of at least the first rotating electric machine out of the first rotating electric machine and the second rotating electric machine. It is possible to achieve these electric travel modes with the dog clutch disengaged. This allows a reduction in energy loss resulting from drag loss in the internal combustion engine when the electric travel modes are performed.

According to the aspect illustrated in FIG. 10 of JP 2010-36880 A, the dog clutch is a clutch for decoupling the input member and the differential gear device from each other. As evidenced by FIG. 10 of JP 2010-36880 A, it is basically necessary that the dog clutch [DC1] and the one-way clutch [OC1] should be axially aligned with each other. Since the technology disclosed in JP 2010-36880 A requires these clutches to be axially aligned with each other, the axial size of the vehicle drive device may be increased accordingly.

### SUMMARY

An exemplary aspect of the present disclosure provides a vehicle drive device that curbs an increase in an axial size of the whole device while having both a clutch for decoupling an input member and a differential gear device from each other and a one-way clutch for restricting rotation of an input rotating element to one direction.

In view of the above, an exemplary vehicle drive device includes: an input member drivingly coupled to an internal combustion engine; an output member drivingly coupled to wheels; a first rotating electric machine; a second rotating electric machine drivingly coupled to the output member; a differential gear device having three rotating elements, namely a first rotating element, a second rotating element, and a third rotating element, in order of rotational speed; and a friction engagement-type first clutch that is located in a power transmission path connecting the input member to the differential gear device and that allows the input member and the differential gear device to be decoupled from each other, in which the first rotating electric machine is drivingly coupled to the first rotating element, the input member is drivingly coupled to an input rotating element that is one of the second rotating element and the third rotating element, the output member is drivingly coupled to an output rotating element that is the other of the second rotating element and the third rotating element, the first clutch includes an inner support member to which a drive force of the input member is input and an outer support member that outputs the drive force input to the inner support member and that is coupled to the input rotating element, at least part of the outer support member is located outside the inner support member in a radial direction with respect to the first clutch, a positive direction is defined as a rotation direction of the outer support member during transmission of rotation of the input member, a negative direction is defined as a rotation direction of the outer support member opposite to the positive direction, and a one-way clutch that allows rotation of the outer support member in the positive direction and that stops rotation of the outer support member in the negative direction is located outside the outer support member in the radial direction so as to overlap the first clutch when viewed in the radial direction.

According to the characteristic structure described above, the one-way clutch that restricts the rotation of the outer support member coupled to the input rotating element to one direction is located outside the outer support member in the radial direction. This facilitates adopting the one-way clutch that has a larger diameter in order to reduce the width of the one-way clutch in the axial direction necessary to ensure a desired torque capacity. Thus, it is possible to reduce the length of the whole device in the axial direction by reducing the width of the one-way clutch in the axial direction. Furthermore, since the one-way clutch is located so as to overlap the first clutch when viewed in the radial direction, it is possible to reduce the length of a space occupied by the one-way clutch and the first clutch in the axial direction, compared to when the one-way clutch is located so as not to overlap the first clutch when viewed in the radial direction.

As such, the characteristic structure described above makes it possible to archive a vehicle drive device that curbs an increase in an axial size of the whole device while having both a clutch for decoupling an input member and a differential gear device from each other and a one-way clutch for restricting rotation of an input rotating element to one direction.

Other features and advantages of the vehicle drive device will be better understood by the following description of embodiments with reference to the drawings.

### BRIEF DESCRIPTION OF THE DRAWINGS

FIG. 1 is a cross-sectional view of part of a vehicle drive device according to an embodiment.

FIG. 2 is a partially enlarged view of FIG. 1.

FIG. 3 is a skeleton diagram illustrating the vehicle drive device according to the embodiment.

### DETAILED DESCRIPTION OF EMBODIMENTS

An embodiment of a vehicle drive device will be described with reference to the drawings. Throughout this description, the expression “drivingly coupled” refers to a state where two rotating elements are coupled such that a drive force is transmittable therebetween. This concept includes a state where two rotating elements are coupled to rotate together and a state where two rotating elements are coupled via one or more transmission members such that a drive force is transmittable therebetween. Such a transmission member includes various types of members (a shaft, a gear mechanism, a belt, a chain, etc.) that transmit rotation while maintaining or changing the speed of rotation, and may include an engagement device (a friction engagement device, an intermesh engagement device, etc.) that selectively transmits rotation and a drive force. However, as for rotating elements of a differential gear device, the expression “drivingly coupled” refers to a state where three or more rotating elements of the differential gear device are drivingly coupled to each other without other rotating elements interposed therebetween.

Throughout this description, the expression “overlap when viewed in a certain direction” used to describe an arrangement of two members means that when an imaginary straight line parallel to the direction of view is moved to directions perpendicular to the imaginary straight line, the imaginary straight line overlaps both of the two members in at least some parts. Furthermore, throughout this description, the expression “extend in a certain direction” used to describe the shape of a member means not only that the member is shaped to extend in a direction parallel to a reference direction that is the certain direction, but also means that the member is shaped to extend in a direction crossing the reference direction at angles within a predetermined range (for example, less than 45 degrees).

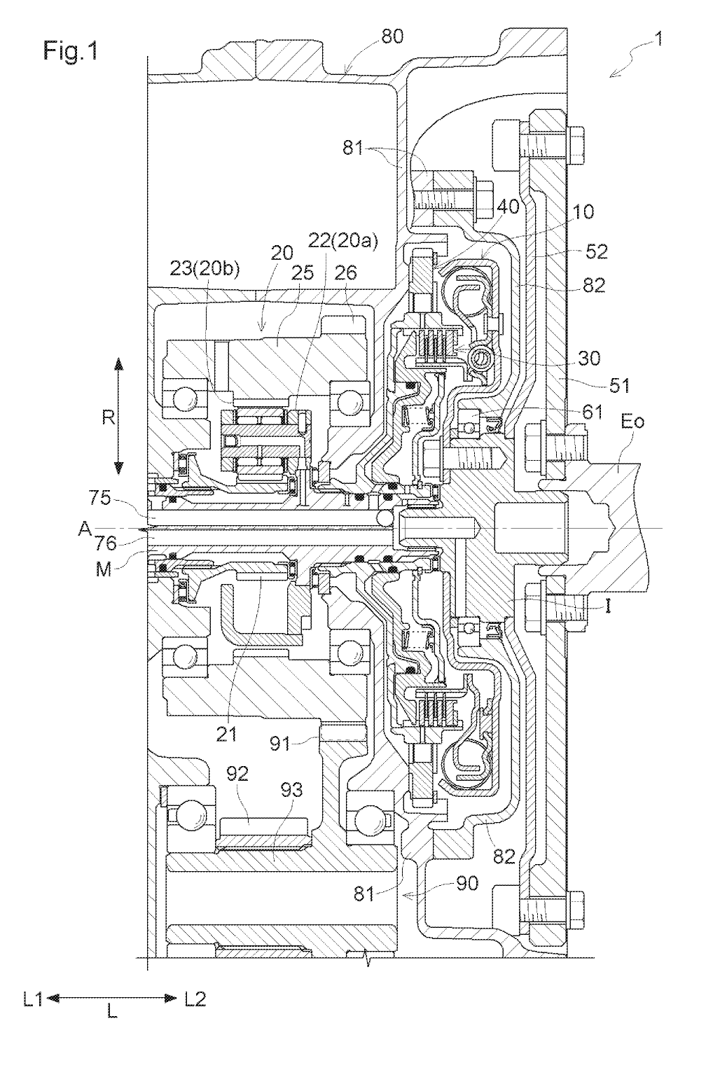

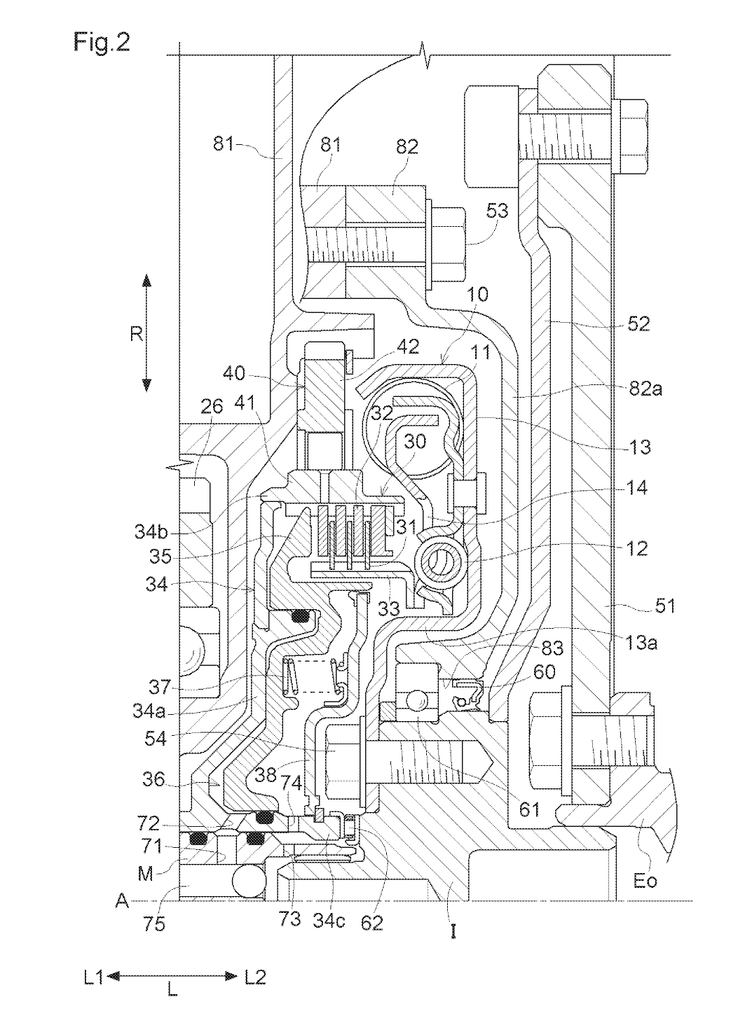

In the description below, unless otherwise specified, the terms “axial direction L”, “radial direction R”, and “circumferential direction” are defined with respect to a damper 10, i.e., defined with respect to the rotation axis of the damper 10 (an axis A, refer to, for example, FIG. 1). It is noted that the rotation axis of the damper 10 is the rotation axis of an input rotating member 13 and an output rotating member 14 (refer to FIG. 2) that are included in the damper 10. According to the present embodiment, a first clutch 30 is concentric with the damper 10. Thus, the directions (the axial direction L, the radial direction R, and the circumferential direction) defined with respect to the damper 10 are the same as the directions defined with respect to the first clutch 30. The term “axial first side L1” refers to one side in the axial direction L, and the term “axial second side L1” refers to the side opposite to the axial first side L1 (the other side in the axial direction L). In the description below, directions used to describe members refer to the directions of the members that are mounted to the vehicle drive device 1. Furthermore, terms related to the directions and positions of the members are used as a concept that allows for permissible manufacturing tolerances.

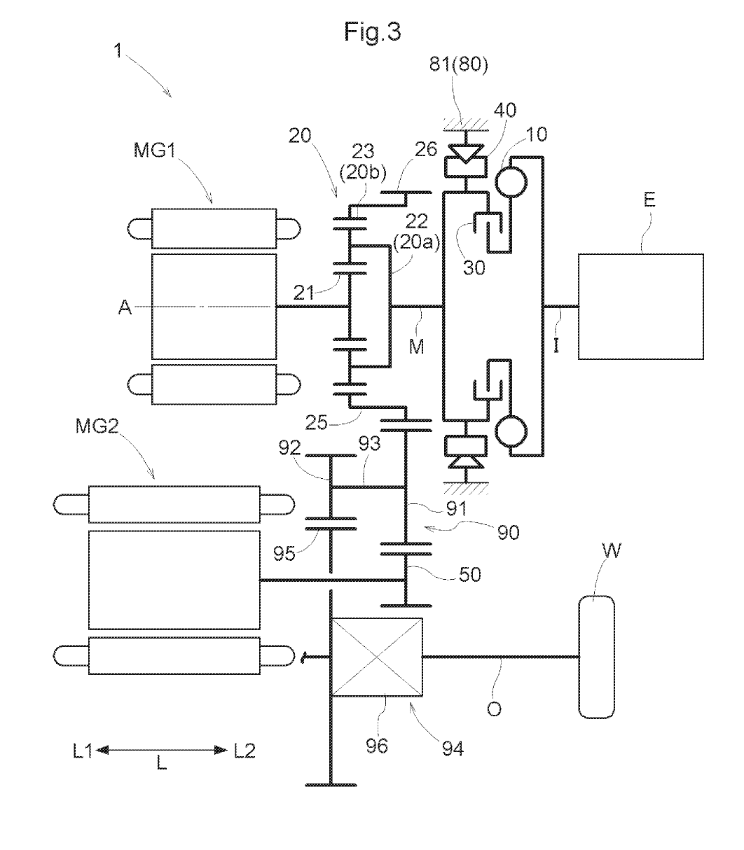

As illustrated in FIG. 3, a vehicle drive device 1 is a drive device (a hybrid vehicle drive device) for driving a vehicle (a hybrid vehicle) that includes, as a source to generate a force to drive a wheel W, an internal combustion engine E and a rotating electric machine (a first rotating electric machine MG1 and a second rotating electric machine MG2). According to the present embodiment, the vehicle drive device 1 is structured as a drive device for a front engine front drive (FF) vehicle. The internal combustion engine E is a motor (for example, a gasoline engine, a diesel engine, etc.) that generates power by being driven by the combustion of a fuel in the engine. The rotating electric machine is used as a concept including a motor (an electric motor), a generator (an alternator), and a motor-generator that serves as either a motor or a generator as needed.

As illustrated in FIG. 3, the vehicle drive device 1 includes an input shaft I drivingly coupled to the internal combustion engine E, an output shaft O drivingly coupled to the wheel W, a first rotating electric machine MG1, a second rotating electric machine MG2, a differential gear device 20, the damper 10, the first clutch 30, and a one-way clutch 40. According to the present embodiment, the vehicle drive device 1 further includes a counter gear mechanism 90 and an output differential gear device 94. Furthermore, the vehicle drive device 1 includes a case 80 (an example of a non-rotating member). As illustrated in FIG. 1, the differential gear device 20, the damper 10, the first clutch 30, and the one-way clutch 40 are housed in the case 80. The first rotating electric machine MG1, the second rotating electric machine MG2, the counter gear mechanism 90, and the output differential gear device 94 are also housed in the case 80. According to the present embodiment, the input shaft I corresponds to an “input member”, and the output shaft O corresponds to an “output member”.

As illustrated in FIG. 1, the input shaft I is drivingly coupled to an internal combustion engine output shaft Eo that is an output shaft (a crank shaft or the like) of the internal combustion engine E. According to the present embodiment, the input shaft I is drivingly coupled to the internal combustion engine output shaft Eo via a flywheel 51 and a plate member 52. Specifically, the internal combustion engine output shaft Eo, the input shaft I, the flywheel 51, and the plate member 52 are all on the axis A (i.e., concentric with each other). An inner peripheral portion of the flywheel 51 that is shaped like an annular disk is coupled (here, fixed by fastening) to the internal combustion engine output shaft Eo, and an outer peripheral portion of the flywheel 51 is coupled (here, fixed by fastening) to an outer peripheral portion of the plate member 52 that is shaped like an annular disk. The plate member 52 is located on the axial first side L1 relative to the flywheel 51. An inner peripheral portion of the plate member 52 is coupled (here, fixed by welding) to the input shaft I. Thus, the input shaft I is coupled via the flywheel 51 and the plate member 52 to the internal combustion engine output shaft Eo so as to rotate along with the internal combustion engine output shaft Eo. According to the present embodiment, a portion of the input shaft I on the axial second side L2 is internally fitted with a cylindrical portion formed at an end of the internal combustion engine output shaft Eo on the axial first side L1 so that the center axes (the rotation axes) of the input shaft I and the internal combustion engine output shaft Eo are aligned (radially aligned) with each other.

The stiffness of the plate member 52 in the axial direction L is set such that the plate member 52 is elastically deformed when an external force in the axial direction L caused by vibrations of the internal combustion engine E is applied to the plate member 52 via the flywheel 51. As such, the plate member 52 is elastically deformed in accordance with the external force in the axial direction L, thereby reducing or absorbing vibration in the axial direction L, out of the vibrations inputted to the plate member 52. Thus, although the internal combustion engine E may vibrate when the internal combustion engine E is driven, the plate member 52 makes it possible to reduce the vibration in the axial direction L transferred to the input shaft I side relative to the plate member 52.

The differential gear device 20 has three rotating elements, namely a first rotating element 21, a second rotating element 22, and a third rotating element 23, in order of rotational speed. The term “order of rotational speed” as used herein refers to the order of the rotational speeds of the rotating elements that are rotating. Although the rotational speeds of the rotating elements change depending on how the differential gear device is rotating, the order of the rotational speeds of the rotating elements is determined by the structure of the differential gear device and therefore remains unchanged. The “order of rotational speed” of the rotating elements is the same as the order of arrangement of the rotating elements in a speed diagram (a collinear diagram). The term “order of arrangement in a speed diagram” as used herein refers to the order in which axes corresponding to the rotating elements are arranged in a direction perpendicular to the axes in the speed diagram (the collinear diagram). Although the direction in which the axes corresponding to the rotating elements are arranged in the speed diagram (the collinear diagram) changes depending on how the speed diagram is drawn, the order of arrangement of the axes is determined by the structure of the differential gear device and therefore remains unchanged. According to the present embodiment, the differential gear device 20 has only the three rotating elements. Specifically, the differential gear device 20 is structured with a single-pinion planetary gear mechanism having a sun gear, a carrier, and a ring gear. The sun gear is the first rotating element 21, the carrier is the second rotating element 22, and the ring gear is the third rotating element 23. According to the present embodiment, as illustrated in FIG. 1, the ring gear (the third rotating element 23) is formed on an inner peripheral surface of a cylindrical differential output member 25. Furthermore, a differential output gear 26 that is an external gear is formed on an outer peripheral surface of the differential output member 25.

Each of the first rotating electric machine MG1 and the second rotating electric machine MG2 has a stator fixed to the case 80 and a rotor supported so as to be free to rotate relative to the stator. Each of the first rotating electric machine MG1 and the second rotating electric machine MG2 is electrically connected to an electricity storage device (a battery, a capacitor, etc.) and supplied with electric power from the electricity storage device so as to perform power running, or supplies, to the electricity storage device, electric power generated by torque of the internal combustion engine E and a vehicle inertia force so as to charge the electricity storage device. The first rotating electric machine MG1 is drivingly coupled to the first rotating element 21 of the differential gear device 20. According to the present embodiment, as illustrated in FIG. 3, the first rotating electric machine MG1 (the rotor of the first rotating electric machine MG1) is coupled so as to rotate along with the first rotating element 21.

The second rotating electric machine MG2 is drivingly coupled to the output shaft O. According to the present embodiment, as illustrated in FIG. 3, the second rotating electric machine MG2 is drivingly coupled to the output shaft O via the counter gear mechanism 90 and the output differential gear device 94. Specifically, the second rotating electric machine MG2 (the rotor of the second rotating electric machine MG2) is coupled so as to rotate along with an output gear 50. The output differential gear device 94 includes an input gear 95 and a body portion 96 coupled to the input gear 95. In the output differential gear device 94, torque and rotation inputted to the input gear 95 is divided through the body portion 96 and transferred to right and left two output shafts O (i.e., right and left two wheels W). The counter gear mechanism 90 includes a first gear 91 that meshes with the output gear 50, a second gear 92 that meshes with the input gear 95, and a coupling shaft 93 that couples the first gear 91 and the second gear 92. As such, output torque of the second rotating electric machine MG2 is transmitted to the output shafts O via the counter gear mechanism 90 and the output differential gear device 94.

The input shaft I is drivingly coupled to an input rotating element 20a that is one of the second rotating element 22 and the third rotating element 23, and the output shafts O is drivingly coupled to an output rotating element 20b that is the other of the second rotating element 22 and the third rotating element 23. According to the present embodiment, as illustrated in FIG. 1 and FIG. 3, the second rotating element 22 is the input rotating element 20a, and the third rotating element 23 is the output rotating element 20b. Thus, according to the present embodiment, the input shaft I is drivingly coupled to the second rotating element 22, and the output shafts O are drivingly coupled to the third rotating element 23. As described later, the input shaft I is drivingly coupled to the second rotating element 22 via the first clutch 30 (according to the present embodiment, via the damper 10 and the first clutch 30). Furthermore, according to the present embodiment, the output shafts O are drivingly coupled to the third rotating element 23 (the output rotating element 20b) via the output differential gear device 94, the counter gear mechanism 90, and the differential output gear 26. Specifically, as illustrated in FIG. 1 and FIG. 3, the differential output gear 26 that rotates along with the third rotating element 23 meshes with the first gear 91 of the counter gear mechanism 90 at a position displaced in a circumferential direction (a circumferential direction with respect to the coupling shaft 93) from a position at which the output gear 50 meshes with, thus causing the third rotating element 23 and the output shafts O to be drivingly coupled to each other. As such, according to the present embodiment, torque transmitted from the second rotating electric machine MG2 and torque transmitted from the differential gear device 20 are combined by the counter gear mechanism 90 and then transmitted to the input gear 95 of the output differential gear device 94. In summary, according to the present embodiment, the counter gear mechanism 90 that transmits a drive force between the differential gear device 20 and the output differential gear device 94 serves also as a drive force transmission mechanism that transmits a drive force between the second rotating electric machine MG2 and the output differential gear device 94.

As illustrated in FIG. 3, the damper 10 and the first clutch 30 are located in a power transmission path that connects the input shaft I to the differential gear device 20 (the input rotating element 20a). In the power transmission path, the first clutch 30 is located closer to the differential gear device 20 than the damper 10. In other words, in the power transmission path, the damper 10 is located closer to the input shaft I than the first clutch 30. Specifically, the first clutch 30 is located in the power transmission path that connects the input shaft I to the differential gear device 20, and according to the present embodiment, the damper 10 and the first clutch 30 are arranged in the power transmission path in this order starting from the input shaft I side. With the first clutch 30 engaged, the input shaft I and the differential gear device 20 are coupled to each other. With the first clutch 30 disengaged, the input shaft I and the differential gear device 20 are decoupled from each other. Thus, the first clutch 30 has the function of disengaging the internal combustion engine E from the wheels W and the rotating electric machine (the first rotating electric machine MG1 and the second rotating electric machine MG2). As describe above, the first clutch 30 is a clutch located in the power transmission path that connects the input shaft I to the differential gear device 20 and is a clutch that allows the input shaft I and the differential gear device 20 to be decoupled from each other.

The one-way clutch 40 is disposed so as to restrict rotation of a later-described outer support member 34 (refer to FIG. 2) of the first clutch 30 to one direction. As described later, the outer support member 34 is coupled via an intermediate shaft M to the input rotating element 20a so as to rotate along with the input rotating element 20a. Regardless of the state of engagement of the first clutch 30, rotation of the outer support member 34 and the input rotating element 20a is restricted to one direction by the one-way clutch 40. Specifically, when a positive direction is defined as a rotation direction of the outer support member 34 during transmission of rotation of the internal combustion engine E (i.e., rotation of the input member I), and a negative direction is defined as a rotation direction of the outer support member 34 opposite to the positive direction, the one-way clutch 40 allows the rotation of the outer support member 34 in the positive direction and stops the rotation of the outer support member 34 in the negative direction (i.e., locks or prohibits the rotation in the negative direction). The expression “during transmission of rotation of the internal combustion engine E (rotation of the input member I)” as used herein refers to a state where the rotation of the internal combustion engine E in combustion operation is being transmitted to the differential gear device 20 side from the input shaft I side via the first clutch 30 that is engaged.

The structure described above enables the vehicle drive device 1 to archive, as a vehicle travel mode, a continuously variable shifting travel mode (according to the present embodiment, a split travel mode), a first electric travel mode, and a second electric travel mode. The continuously variable shifting travel mode is a travel mode where the speed of rotation of the input shaft I is continuously changed and transmitted to the output shafts O (the wheels W). The continuously variable shifting travel mode is achieved with the first clutch 30 engaged. In the continuously variable shifting travel mode, the differential gear device 20 serves as a power distribution device that distributes, between the first rotating element 21 and the third rotating element 23, torque of the input shaft I (torque of the internal combustion engine E) transmitted to the second rotating element 22. Torque dampened relative to the torque of the input shaft I is distributed to the third rotating element 23 and is used to drive the wheels W. The first rotating electric machine MG1 outputs torque as a reaction force to the torque distributed to the first rotating element 21. At this time, the first rotating electric machine MG1 basically serves as a generator and generates electricity by using the torque distributed to the first rotating element 21. On the other hand, the second rotating electric machine MG2 outputs torque to compensate for the shortage of wheel required torque (torque required to be transmitted to the wheels W) as needed.

During the continuously variable shifting travel mode, the first clutch 30 has an engagement pressure that is set greater than a pressure value for preventing the first clutch 30 from slipping due to the torque transmitted from the internal combustion engine E to the first clutch 30 and that is set to cause the state of engagement of the first clutch 30 to transition from a direct engagement state (an engagement state where there is no rotation speed difference between a later-described first friction member 31 and a later-described second friction member 32) to a slip engagement state (an engagement state where there is a rotation speed difference between the later-described first friction member 31 and the later-described second friction member 32) when excessive torque is transmitted between the internal combustion engine E and the wheels W. Thus, the engagement pressure of the first clutch 30 is set such that the first clutch 30 serves as a torque limiter. This prevents components (gears, shafts, etc.) of the vehicle drive device 1 from being subjected to loads beyond their respective strength limits, thus protecting the components of the vehicle drive device 1. Such excessive torque may occur, for example, at the moment when a vehicle lands on a road after running over a bump with the wheels W idly spinning. As described later, according to the present embodiment, the first clutch 30 is a wet friction clutch and is thus expected to serve as a torque limiter more stably, compared to when a dry torque limiter is used. The pressure value for preventing the first clutch 30 from slipping due to the torque transmitted from the internal combustion engine E to the first clutch 30 is set to, for example, the lower limit of an engagement pressure that maintains the first clutch 30 in the direct engagement state while the maximum output torque of the internal combustion engine E or the sum of the maximum output torque of the internal combustion engine E and a predetermined value (e.g., a value that allows for torque fluctuations) is transmitted to the first clutch 30.

The first electric travel mode is a travel mode where torque of only the second rotating electric machine MG2 is transmitted to the output shafts O (the wheels W). Thus, the first electric travel mode uses the torque of only the second rotating electric machine MG2 to cause the vehicle to travel. In the first electric travel mode, basically, the first clutch 30 is disengaged in order not to cause drag rotation of the internal combustion engine E, and the rotation speed of the first rotating element 21 is set to zero in order not to cause drag rotation of the first rotating electric machine MG1. Specifically, during the first electric travel mode, the first clutch 30 is disengaged so that the input rotating element 20a (the second rotating element 22) and the input shaft I are decoupled from each other. Thus, the rotation speed of the input rotating element 20a can be set independently of the rotation speed of the internal combustion engine E. This makes it possible that the rotation speed of the first rotating electric machine MG1 drivingly coupled to the first rotating element 21 is maintained at zero during the first electric travel mode, thus reducing an increase in fuel consumption during the first electric travel mode.

The second electric travel mode is a travel mode where torques of both the first rotating electric machine MG1 and the second rotating electric machine MG2 are transmitted to the output shafts O (the wheels W). Thus, the second electric travel mode uses the torques of both the first rotating electric machine MG1 and the second rotating electric machine MG2 to cause the vehicle to travel. In the second electric travel mode, a reaction force of the torque of the first rotating electric machine MG1 transmitted to the first rotating element 21 is received by the input rotating element 20a that is prohibited from rotating in the negative direction (i.e., stopped from rotating in the negative direction) by the one-way clutch 40, so that the torque of the first rotating electric machine MG1 is transmitted to the output shafts O via the output rotating element 20b (the third rotating element 23). At this time, the second rotating electric machine MG2 outputs torque to partially satisfy the wheel required torque, and the first rotating electric machine MG1 outputs torque to compensate for the shortage of the wheel required torque. In the second electric travel mode, basically, the first clutch 30 is disengaged. As described above, even with the first clutch 30 disengaged, the reaction force of the torque of the first rotating electric machine MG1 transmitted to the first rotating element 21 is received by the input rotating element 20a that is rotationally restricted (i.e., stopped from rotating in the negative direction) by the one-way clutch 40. Thus, even with the first clutch 30 disengaged, the torque of the first rotating electric machine MG1 is transmitted to the output shafts O via the output rotating element 20b (the third rotating element 23). This allows a transition to occur, with the first clutch 30 disengaged, from the first electric travel mode to the second electric travel mode where the torques of both the first rotating electric machine MG1 and torque of the second rotating electric machine MG2 are transmitted to the output member. This ensures suitable responsiveness of the transition from the first electric travel mode to the second electric travel mode while reducing an increase in fuel consumption during the first electric travel mode.

The specific structure and arrangement of the damper 10, the first clutch 30, and the one-way clutch 40 according to the present embodiment will be described below.

As illustrated in FIG. 2, the damper 10 includes the input rotating member 13 coupled to the input shaft I, the output rotating member 14 coupled to a later-described inner support member 33 of the first clutch 30, and a spring member (an elastic member) that transmits torque between the input rotating member 13 and the output rotating member 14. The output rotating member 14 is located on the axial first side L1 relative to the input rotating member 13. The spring member is elastically deformed in accordance with a relative rotational displacement (a relative displacement in the circumferential direction) between the input rotating member 13 and the output rotating member 14, thereby reducing or absorbing torsional vibrations input to the damper 10. Thus, although torque fluctuations of the internal combustion engine E may cause torsion vibrations at the internal combustion engine output shaft Eo, providing the damper 10 allows reducing the torsion vibrations transferred to the wheel W side relative to the damper 10. According to the present embodiment, the spring member is structured with a coil spring. The spring member is arranged along the circumferential direction. For example, when viewed in the axial direction L, the spring member has an arc shape. According to the present embodiment, the input rotating member 13 corresponds to an “input-side member”, and the output rotating member 14 corresponds to an “output-side member”.

According to the present embodiment, the input rotating member 13 is coupled so as to rotate along with the input shaft I. Specifically, when viewed in the axial direction L, the input rotating member 13 has an annular shape with an axis coincident with the axis A, and an inner peripheral portion of the input rotating member 13 is coupled (in this example, fixed by fastening) to the input shaft I. In the example illustrated in FIG. 2, the input rotating member 13 is fixed to the input shaft I by a second fastening member 54 inserted therethrough from the axial first side L1 and abuts, from the axial first side L1, against an end surface of the input shaft I facing toward the axial first side L1. Furthermore, according to the present embodiment, the output rotating member 14 is coupled so as to rotate along with the inner support member 33 of the first clutch 30. Specifically, when viewed in the axial direction L, the output rotating member 14 has an annular shape with its axis coincident with the axis A, and an inner peripheral portion of the output rotating member 14 is coupled to the inner support member 33. The output rotating member 14 and the inner support member 33 are coupled together, for example, by fixing them together by welding, riveting, etc.

According to the present embodiment, the damper 10 includes a plurality of spring members that are arranged at different locations in the radial direction R. Specifically, the damper 10 includes a first spring member 11 and a second spring member 12 that is located on the inner side with respect to the first spring member 11 in the radial direction R. According to the present embodiment, the first spring member 11 is disposed along the outer peripheral portion of the damper 10. Although not illustrated in the drawings, the damper 10 includes a plurality of the first spring members 11 that are distributed in the circumferential direction and a plurality of the second spring members 12 that are distributed in the circumferential direction. According to the present embodiment, the first spring members 11 are larger in coil diameter than the second spring members 12. Furthermore, according to the present embodiment, the center of the first spring members 11 in the axial direction L is located on the axial first side L1 relative to the center of the second spring members 12 in the axial direction L. The first spring members 11 and the second spring members 12 are disposed, for example, such that when the relative rotational displacement between the input rotating member 13 and the output rotating member 14 is small, only the first spring members 11 are elastically deformed, and such that when the relative rotational displacement is greater than or equal to a predetermined value, both the first spring members 11 and the second spring members 12 are elastically deformed. According to the present embodiment, the first spring members 11 correspond to a “spring member”.

The first clutch 30 is a friction engagement-type clutch. According to the present embodiment, the first clutch 30 is a hydraulically actuated clutch. The first clutch 30 is concentric with the damper 10 (i.e., on the axis A). According to the present embodiment, the differential gear device 20 is also concentric with the damper 10. Thus, the differential gear device 20 is concentric with the first clutch 30. As illustrated in FIG. 1, the first clutch 30 is located between the damper 10 and the differential gear device 20 in the axial direction L. As illustrated in FIG. 2, the first clutch 30 includes the following: the inner support member 33 that supports the first friction member 31 from the inner side in the radial direction R; and the outer support member 34 that supports, from the outer side in the radial direction R, the second friction member 32 that engages frictionally with the first friction member 31. At least part of the outer support member 34 is located outside the inner support member 33 in the radial direction R. According to the present embodiment, a later-described first tubular portion 34b is located outside the inner support member 33 in the radial direction R. The first clutch 30 further includes a piston 35 that presses the first friction member 31 and the second friction member 32 in the axial direction L. Each of the first friction member 31 and the second friction member 32 has an annular disk shape with its axis coincident with the axis A. The first friction member 31 is supported so as to be free to slide in the axial direction L while being prohibited from rotating in the circumferential direction, relative to the inner support member 33. The second friction member 32 is supported so as to be free to slide in the axial direction L while being prohibited from rotating in the circumferential direction, relative to the outer support member 34. At least one of the first friction member 31 and the second friction member 32 has a plurality of friction members, and according to the present embodiment, each of the first friction member 31 and the second friction member 32 has a plurality of friction members. Specifically, according to the present embodiment, the inner support member 33 supports a plurality of the first friction members 31 that are arranged in the axial direction L. Furthermore, according to the present embodiment, the outer support member 34 supports a plurality of the second friction members 32 that are arranged in the axial direction L. The first friction members 31 and the second friction members 32 are alternately arranged one by one in the axial direction L.

The inner support member 33 is coupled to the damper 10, and the outer support member 34 is coupled to the input rotating element 20a. As such, with the first clutch 30 engaged, a friction force generated between the first friction members 31 and the second friction members 32 transmits torque between the damper 10 and the input rotating element 20a. Thus, the inner support member 33 is a member to which the drive force of the input shaft I is input, and the outer support member 34 is a member from which the drive force input to the inner support member 33 is output. According to the present embodiment, the inner support member 33 is coupled so as to rotate along the output rotating member 14 of the damper 10. Specifically, the inner support member 33 includes the following: a tubular portion that has an axis coincident with the axis A and that supports the first friction members 31; and a radial extension portion extending inward from the tubular portion (in this example, an end of the tubular portion on the axial second side L2) in the radial direction R. The radial extension portion of the inner support member 33 is coupled to the inner peripheral portion of the output rotating member 14 of the damper 10. Furthermore, according to the present embodiment, the outer support member 34 is coupled via the intermediate shaft M so as to rotate along with the input rotating element 20a. Specifically, the outer support member 34 includes the following: the first tubular portion 34b that has an axis coincident with the axis A and that supports the second friction members 32; a second tubular portion 34c that has an axis coincident with the axis A and that is smaller in diameter than the first tubular portion 34b; and a radial extension portion 34a that extends in the radial direction R and that connects the first tubular portion 34b and the second tubular portion 34c. As illustrated in FIG. 1, the input rotating element 20a is coupled so as to rotate along with the intermediate shaft M, and the second tubular portion 34c is coupled to (in this example, splined to) the intermediate shaft M and is located outside the intermediate shaft M in the radial direction R. As such, the outer support member 34 is coupled via the intermediate shaft M so as to rotate along with the input rotating element 20a. The radial extension portion 34a extends inward from the first tubular portion 34b (in this example, an end of the first tubular portion 34b on the axial first side L1) in the radial direction R. Furthermore, when viewed in the axial direction L, the radial extension portion 34a has an annular shape with its axis coincident with the axis A.

According to the present embodiment, as illustrated in FIG. 2, the piston 35 of the first clutch 30 is structured to press the first friction members 31 and the second friction members 32 from the axial first side L1 (from the differential gear device 20 side in the axial direction L). The radial extension portion 34a of the outer support member 34 is located on the axial first side L1 (on the differential gear device 20 side in the axial direction L) relative to the piston 35 and extends in the radial direction R. A cylinder chamber 36 is formed between the radial extension portion 34a and the piston 35 in the axial direction L to be supplied with oil pressure that is used to drive the piston 35. The piston 35 is biased by a biasing member 37 in a direction (toward the axial first side L1) opposite to a direction in which the first friction members 31 and the second friction members 32 are pressed. The biasing member 37 is located between the piston 35 and a cancel plate 38 in the axial direction L. The movement of the cancel plate 38 in the axial direction L is restricted. The piston 35 moves in the axial direction L in accordance with the oil pressure in the cylinder chamber 36, thus controlling the state of engagement of the first clutch 30. According to the present embodiment, the piston 35 is coupled so as to rotate along with the outer support member 34, and the piston 35 contacts the second friction member 32 when pressing the first friction members 31 and the second friction members 32. The second friction member 32 located closest to the axial second side L2 serves as a pressing member (a back plate) and is identical in structure to the other second friction members 32 except for their thickness (their width in the axial direction L).

The cylinder chamber 36 is supplied with oil pressure that has been controlled by a hydraulic control device (not illustrated). According to the present embodiment, as illustrated in FIG. 2, the oil pressure that has been controlled by the hydraulic control device is supplied to the cylinder chamber 36 by way of the following: a first in-shaft oil passage 75 extending through the intermediate shaft M in the axial direction L; a first oil hole 71 extending through the tubular portion of the intermediate shaft M in the radial direction R; and a second oil hole 72 extending through the second tubular portion 34c of the outer support member 34 in the radial direction R. That is, forming the cylinder chamber 36 between the piston 35 and the radial extension portion 34a that is located on the axial first side L1 relative to the piston 35 makes it possible to simplify the structure of an oil passage to supply oil to the cylinder chamber 36. Specifically, assuming that a cylinder chamber is located on the axial second side L2 relative to the piston 35 in contrast to the present embodiment, it is common to employ a structure in which oil is supplied to the cylinder chamber through an oil passage formed in the input shaft I. In this case, to supply oil in an oil passage formed in the intermediate shaft M to the cylinder chamber, it is necessary to maintain suitable oil pressure while supplying the oil in the oil passage formed in the intermediate shaft M to the oil passage formed in the input shaft I, or to supply oil to the cylinder chamber through an oil passage formed in the case 80, it is necessary to form the oil passage in a wall portion of the case 80 that supports the input shaft I. In either case, the structure of an oil passage to supply oil to the cylinder chamber tends to become complex. In contrast, according to the embodiment, the cylinder chamber 36 is located on the axial first side L1 relative to the piston 35. This structure facilitates supplying oil to the cylinder chamber 36 without passing an oil passage formed in the input shaft I, which simplifies the structure of an oil passage to supply oil to the cylinder chamber 36.

As illustrated in FIG. 2, a cancel chamber for canceling centrifugal oil pressure generated in the cylinder chamber 36 is formed between the piston 35 and the cancel plate 38 in the axial direction L. Oil pressure that has been controlled by the hydraulic control device is supplied to the cancel chamber by way of the following: a second in-shaft oil passage 76 (refer to FIG. 1) extending through the intermediate shaft M in the axial direction L; a third oil hole 73 extending through the tubular portion of the intermediate shaft M in the radial direction R; and a fourth oil hole 74 extending through the second tubular portion 34c of the outer support member 34 in the radial direction R. Furthermore, according to the present embodiment, the first clutch 30 is a wet friction clutch. Thus, the first friction members 31 and the second friction members 32 of the first clutch 30 are supplied with oil. According to the present embodiment, the oil pressure that has been controlled by the hydraulic control device is supplied to the first friction members 31 and the second friction members 32 by way of the second in-shaft oil passage 76, the third oil hole 73, and a second bearing 62. Specifically, as illustrated in FIG. 2, the second bearing 62 is located between the input shaft I and the second tubular portion 34c of the outer support member 34 and is a thrust bearing capable of receiving a load in the axial direction L. The oil that has lubricated the second bearing 62 is supplied to the first friction members 31 and the second friction members 32. The oil that has lubricated the second bearing 62 is also supplied to the damper 10 and the one-way clutch 40. That is, according to the present embodiment, the damper 10 is a wet damper. This allows the damper 10 to serve more stably, compared to when a dry damper is used, and also eliminates the need to place parts, made of resin or the like, between sliding portions of different members of the damper, thus reducing the size of the damper 10 accordingly.

The one-way clutch 40 is concentric with the damper 10 (i.e., on the axis A). That is, the one-way clutch 40 is concentric with the first clutch 30. Furthermore, as illustrated in FIG. 1, the one-way clutch 40 is located between the damper 10 and the differential gear device 20 in the axial direction L, i.e., located on the axial first side L1 relative to the damper 10. In other words, the one-way clutch 40 is located on the axial second side L2 relative to the differential gear device 20. Furthermore, the one-way clutch 40 is located outside the outer support member 34 in the radial direction R.

As illustrated in FIG. 2, the one-way clutch 40 includes an inner ring 41, an outer ring 42, and drive force transmission members (rollers, sprags, etc.) that selectively transmit a drive force between the inner ring 41 and the outer ring 42. The one-way clutch 40 restricts relative rotation between the inner ring 41 and the outer ring 42 to one direction. As already described, the one-way clutch 40 allows the rotation of the outer support member 34 in the positive direction and stops the rotation of the outer support member 34 in the negative direction (i.e., locks or prohibits the rotation in the negative direction). Thus, one of the inner ring 41 and the outer ring 42 is fixed to the case 80, and the other of the inner ring 41 and the outer ring 42 is coupled to the outer support member 34. According to the present embodiment, as illustrated in FIG. 2, the outer ring 42 is fixed to the case, and the inner ring 41 is coupled to the outer support member 34. Specifically, the case 80 includes a first case member 81 that supports the one-way clutch 40, and the outer ring 42 is fixed to the first case member 81. In this example, the outer ring 42 is fixed to the first case member 81 by being in spline engagement with the inner peripheral surface of a tubular portion formed in the first case member 81. The inner ring 41 is coupled so as to rotate along with the outer support member 34. According to the present embodiment, the inner ring 41 is formed as one piece with the outer support member 34 (the first tubular portion 34b). Specifically, a portion that supports the second friction members 32 is formed on the inner peripheral portion of the first tubular portion 34b, and the inner ring 41 is formed on the outer peripheral portion of the first tubular portion 34b. This allows a reduction in device size, compared to when the inner ring 41 is a separate piece from the outer support member 34, and also allows a reduction in the number of parts, thus allowing a reduction in device cost. Alternatively, the inner ring 41 may be a separate piece from the outer support member 34.

As illustrated in FIG. 2, according to the present embodiment, the one-way clutch 40 is located so as to overlap the first clutch 30 when viewed in the radial direction R. Specifically, the one-way clutch 40 is located outside the outer support member 34 in the radial direction R so as to overlap the first clutch 30 when viewed in the radial direction R. According to the present embodiment, the whole of the one-way clutch 40 overlaps the first clutch 30 when viewed in the radial direction R, specifically, overlaps the first tubular portion 34b of the outer support member 34 when viewed in the radial direction R. Furthermore, according to the present embodiment, when viewed in the radial direction R, the whole of the one-way clutch 40 overlaps the areas where the first friction members 31, the second friction members 32, and the piston 35 are located (the sum of the area where the first friction members 31 are located, the area where the second friction members 32 are located, and the area where the piston 35 is located). Moreover, according to the present embodiment, the damper 10 is also located so as to overlap the first clutch 30 when viewed in the radial direction R. According to the present embodiment, part of the damper 10 on the axial first side L1 overlaps the first clutch 30 when viewed in the radial direction R. Specifically, the first spring members 11 of the damper 10 are located outside the second friction members 32 in the radial direction R so as to overlap the one-way clutch 40 when viewed in the axial direction L. The first spring members 11 are located outside the first clutch 30 in the radial direction R so as to overlap the first clutch 30 when viewed in the radial direction R. Specifically, a part of the first spring members 11 on the axial first side L1 partially overlaps the first clutch 30 (the first tubular portion 34b) when viewed in the radial direction R. As such, according to the present embodiment, the first spring members 11 are located so as to overlap the one-way clutch 40 when viewed in the axial direction L and so as to overlap the first clutch 30 when viewed in the radial direction R. Disposing the one-way clutch 40 outside the outer support member 34 in the radial direction R allows the one-way clutch 40 to have a larger diameter, thus making it possible to reduce the width of the one-way clutch 40 in the axial direction L accordingly while ensuring the necessary torque capacity. Therefore, it is possible to make the width of the one-way clutch 40 in the axial direction L shorter than the width of the first tubular portion 34b in the axial direction L in order to provide a space where the first spring members 11 are arranged at a location that is outside the first tubular portion 34b in the radial direction R and that overlaps the first tubular portion 34b when viewed in the radial direction R. This allows the first spring members 11 to have a larger diameter while reducing the areas where the one-way clutch 40, the first clutch 30, and the damper 10 are located (the sum of the area where the one-way clutch 40 is located, the area where the first clutch 30 is located, and the area where the damper 10 is located) in the axial direction L and in the radial direction R.

Furthermore, according to the present embodiment, as illustrated in FIG. 2, the input rotating member 13 of the damper 10 has an axial extension portion 13a that is located between inner and outer peripheral portions thereof and that extends in the axial direction L. The inner peripheral portion (the portion coupled to the input shaft I) of the input rotating member 13 is displaced by the length of the axial extension portion 13a in the axial direction L toward the axial first side L1 from a portion of the input rotating member 13 that faces the spring member (in this example, the first spring members 11 and the second spring members 12) in the axial direction L. Furthermore, the inner peripheral portion of the input rotating member 13 is located inside the first clutch 30 (the inner support member 33) in the radial direction R so as to overlap the first clutch 30 (the inner support member 33) when viewed in the radial direction R.

According to the present embodiment, as illustrated in FIG. 1, the case 80 includes a second case member 82 attached to the first case member 81. That is, the second case member 82 is a separate piece from the first case member 81. As illustrated in FIG. 2, according to the present embodiment, a first fastening member 53 fixes the second case member 82 to the first case member 81 from the axial second side L2. The second case member 82 includes a radial wall portion 82a extending in the radial direction R. The radial wall portion 82a is disposed between the plate member 52 and the damper 10 in the axial direction L so as to extend in the radial direction R. Thus, the damper 10 and the first clutch 30 are located on the axial first side L1 (on the differential gear device 20 side in the axial direction L) relative to the radial wall portion 82a. According to the present embodiment, the one-way clutch 40 is also located on the axial first side L1 relative to the radial wall portion 82a.

As illustrated in FIG. 2, the radial wall portion 82a has a through hole 83 extending therethrough in the axial direction L. When viewed in the axial direction L, the through hole 83 has a circular shape with its axis coincident with the axis A. The input shaft I is inserted through the through hole 83 and is rotatably supported by the second case member 82 via a first bearing 61 that is disposed on the inner peripheral surface of the through hole 83. The first bearing 61 is a radial bearing (in this example, a ball bearing) capable of receiving a load in the radial direction R. According to the present embodiment, a sealing member 60 is located on the axial second side L2 relative to the first bearing 61 on the inner peripheral surface of the through hole 83 and is in contact with both the inner peripheral surface of the through hole 83 and the outer peripheral surface of the input shaft I. According to the present embodiment, the first bearing 61 is located inside the damper 10 in the radial direction R so as to overlap the damper 10 when viewed in the radial direction R. According to the present embodiment, the sealing member 60 is also located inside the damper 10 in the radial direction R so as to overlap the damper 10 when viewed in the radial direction R. According to the present embodiment, as already described, the input rotating member 13 includes the axial extension portion 13a, and there is a cylindrical space both ends of which in the radial direction R are defined by the axial extension portion 13a and the input shaft I. The first bearing 61, the sealing member 60, and a portion of the second case member 82 (the radial wall portion 82a) that defines the through hole 83 are located in the cylindrical space. According to the present embodiment, the first bearing 61 corresponds to a “bearing”.

As already described, according to the present embodiment, the second case member 82 that supports the input shaft I via the first bearing 61 is a separate piece from the first case member 81. This facilitates mounting the damper 10 in the manufacture of the vehicle drive device 1. Specifically, according to the present embodiment, as already described, the input rotating member 13 of the damper 10 is fixed to the input shaft I by the second fastening member 54 that is inserted therethrough from the axial first side L1. Therefore, if the second case member 82 that supports the input shaft I is formed as one piece with the first case member 81, it is not easy to fix the input rotating member 13 to the input shaft I by the second fastening member 54, as evidenced by FIG. 2. In contrast, as in the present embodiment, when the second case member 82 is a separate piece from the first case member 81, it is possible to attach the second case member 82 to the first case member 81 after the first bearing 61, the sealing member 60, the input shaft I, the damper 10, etc. are mounted to the second case member 82 that is still separated from the first case member 81. This makes it relatively easy to mount the damper 10.

### Other Embodiments

Other embodiments of the vehicle drive device will be described. It is noted that, as long as there is no inconsistency, structures disclosed in any one of the embodiments described below may be used in combination with structures disclosed in any other of the embodiments.

(1) According to the example described in the above embodiment, each of the one-way clutch 40 and the damper 10 is located so as to overlap the first clutch 30 when viewed in the radial direction R. However, without being limited to such a structure, only one of the one-way clutch 40 and the damper 10 may be located so as to overlap the first clutch 30 when viewed in the radial direction R, or each of the one-way clutch 40 and the damper 10 may be disposed in an area that is different in the axial direction L from the area where the first clutch 30 is disposed so as not to overlap the first clutch 30 when viewed in the radial direction R.

(2) According to the example described in the above embodiment, the damper 10 includes the first spring members 11 that are located outside the second friction member 32 in the radial direction R so as to overlap the one-way clutch 40 when viewed in the axial direction L, and the first spring members 11 are located so as to overlap the first clutch 30 when viewed in the radial direction R. However, without being limited to such a structure, the first spring members 11 may be disposed in an area that is different in the axial direction L from the area where the first clutch 30 is disposed so as not to overlap the first clutch 30 when viewed in the radial direction R. Alternatively, the damper 10 may include no first spring members 11 that are located outside the second friction member 32 in the radial direction R and that overlap the one-way clutch 40 when viewed in the axial direction L.

(3) According to the example described in the above embodiment, the damper 10 includes a plurality of spring members that are arranged at different locations in the radial direction R. However, without being limited to such a structure, the damper 10 may include only one spring member or a plurality of spring members that are arranged at the same location in the radial direction R. For example, the damper 10 may include only the first spring members 11 described in the above embodiment, or the damper 10 may include only the second spring members 12 described in the above embodiment.

(4) According to the example described in the above embodiment, the piston 35 is structured to press the first friction members 31 and the second friction members 32 from the axial first side L1, and the cylinder chamber 36 is formed between the radial extension portion 34a and the piston 35 in the axial direction L. However, without being limited to such a structure, the piston 35 may be structured to press the first friction members 31 and the second friction members 32 from the axial second side L2, and a cylinder chamber may be formed between the piston 35 and a member that is disposed on the axial second side L2 relative to the piston 35.

(5) According to the example described in the above embodiment, the first case member 81 and the second case member 82 are separate pieces. However, without being limited to such a structure, for example, the first case member 81 and the second case member 82 may be formed as one piece.

(6) According to the example described in the above embodiment, the counter gear mechanism 90 that transmits the drive force between the differential gear device 20 and the output differential gear device 94 serves also as the drive force transmission mechanism that transmits the drive force between the second rotating electric machine MG2 and the output differential gear device 94. However, without being limited to such a structure, the drive force transmission mechanism that transmits the drive force between the second rotating electric machine MG2 and the output differential gear device 94 may be provided separately from the counter gear mechanism 90. Furthermore, the differential output gear 26 of the differential gear device 20 may mesh with the input gear 95 of the output differential gear device 94, or the output gear 50 coupled to the second rotating electric machine MG2 may mesh with the input gear 95 of the output differential gear device 94.

(7) According to the example described in the above embodiment, the second rotating element 22 is the input rotating element 20a, and the third rotating element 23 is the output rotating element 20b. However, without being limited to such a structure, the third rotating element 23 may be the input rotating element 20a while the second rotating element 22 may be the output rotating element 20b, i.e., the input shaft I may be drivingly coupled to the third rotating element 23 while the output shafts O may be drivingly coupled to the second rotating element 22. In this case, in the continuously variable shifting travel mode, the differential gear device 20 combines torque of the input shaft I (torque of the internal combustion engine E) transmitted to the third rotating element 23 with torque of the first rotating electric machine MG1 transmitted to the first rotating element 21 so that torque amplified relative to the torque of the input shaft I is transmitted to the output shafts O via the second rotating element 22. Furthermore, in the second electric travel mode, a reaction force of the torque of the first rotating electric machine MG1 transmitted to the first rotating element 21 is received by the third rotating element 23 that is prohibited from rotating in the negative direction (i.e., stopped from rotating in the negative direction) by the one-way clutch 40, so that the torque of the first rotating electric machine MG1 is transmitted to the output shafts O via the second rotating element 22.

(8) According to the example described in the above embodiment, the differential gear device 20 is structured with a single-pinion planetary gear mechanism. However, without being limited to such a structure, the differential gear device 20 may be structured with a double-pinion planetary gear mechanism. Furthermore, according to the example described in the above embodiment, the differential gear device 20 has only three rotating elements, namely the first rotating element 21, the second rotating element 22, and the third rotating element 23. However, without being limited to such a structure, the differential gear device 20 may have four or more rotating elements including the first rotating element 21, the second rotating element 22, and the third rotating element 23. For example, a differential gear device that is structured with a Ravigneaux planetary gear mechanism or a differential gear device that is structured with a combination of two single-pinion planetary gear mechanisms so as to have four or more rotating elements may be used as the differential gear device 20. When the differential gear device 20 has a fourth rotating element in addition to the first rotating element 21, the second rotating element 22, and the third rotating element 23, for example, the second rotating electric machine MG2 may be drivingly coupled to the fourth rotating element.

(9) According to the example described in the above embodiment, the vehicle drive device 1 includes the damper 10. However, without being limited to such a structure, the vehicle drive device 1 may include no damper 10, and the input shaft I may be coupled to the inner support member 33 of the first clutch 30 directly or via another member (other than the damper 10). In this case, each of the directions (the axial direction L, the radial direction R, and the circumferential direction) described above may be defined with respect to the first clutch 30.

(10) For other structures, the embodiments disclosed in this description should be considered in all aspect as merely illustrative as well. Thus, various modifications that fall within the spirit of the present disclosure may be made as appropriate by those skilled in the art.

### Summary of the Embodiments

The vehicle drive device described above will be summarized below.

A vehicle drive device (1) includes: an input member (I) drivingly coupled to an internal combustion engine (E); an output member (O) t drivingly coupled to wheels (W); a first rotating electric machine (MG1); a second rotating electric machine (MG2) drivingly coupled to the output member (O); a differential gear device (20) having three rotating elements, namely a first rotating element (21), a second rotating element (22), and a third rotating element (23), in order of rotational speed; and a friction engagement-type first clutch (30) that is located in a power transmission path connecting the input member (I) to the differential gear device (20) and that allows the input member (I) and the differential gear device (20) to be decoupled from each other, in which the first rotating electric machine (MG1) is drivingly coupled to the first rotating element (21), the input member (I) is drivingly coupled to an input rotating element (20a) that is one of the second rotating element (22) and the third rotating element (23), the output member (O) is drivingly coupled to an output rotating element (20b) that is the other of the second rotating element (22) and the third rotating element (23), the first clutch (30) includes an inner support member (33) to which a drive force of the input member (I) is input, and an outer support member (34) that outputs the drive force input to the inner support member (33) and that is coupled to the input rotating element (20a), at least part of the outer support member (34) is located outside the inner support member (33) in a radial direction (R) with respect to the first clutch (30), a positive direction is defined as a rotation direction of the outer support member (34) during transmission of rotation of the input member (I), a negative direction is defined as a rotation direction of the outer support member (34) opposite to the positive direction, and a one-way clutch (40) that allows rotation of the outer support member (34) in the positive direction and that stops rotation of the outer support member (34) in the negative direction is located outside the outer support member (34) in the radial direction (R) so as to overlap the first clutch (30) when viewed in the radial direction (R).

According to this structure, the one-way clutch (40) that restricts the rotation of the outer support member (34) coupled to the input rotating element (20a) to one direction is located outside the outer support member (34) in the radial direction (R). This facilitates adopting the one-way clutch (40) that has a larger diameter in order to reduce the width of the one-way clutch (40) in the axial direction (L) necessary to ensure a desired torque capacity. Thus, it is possible to reduce the length of the whole device in the axial direction (L) by reducing the width of the one-way clutch (40) in the axial direction (L). Furthermore, since the one-way clutch (40) is located so as to overlap the first clutch (30) when viewed in the radial direction (R), it is possible to reduce the length of a space occupied by the one-way clutch (40) and the first clutch (30) in the axial direction (L), compared to when the one-way clutch (40) is located so as not to overlap the first clutch (30) when viewed in the radial direction (R).

As such, the structure described above makes it possible to archive the vehicle drive device (1) that curbs an increase in the size of the whole device in the axial direction (L) while having both the clutch (30) for decoupling the input member (I) and the differential gear device (20) from each other and the one-way clutch (40) for restricting rotation of the input rotating element (20a) to one direction.

Preferably, the vehicle drive device (1) may include a damper (10) that is located closer to the input member (I) than the first clutch (30) in the power transmission path and that is concentric with the first clutch (30), in which the inner support member (33) supports a first friction member (31) from inside in the radial direction (R), the outer support member (34) supports, from outside in the radial direction (R), a second friction member (32) that engages frictionally with the first friction member (31), an input-side member (13) of the damper (10) is coupled to the input member (I), and an output-side member (14) of the damper (10) is coupled to the inner support member (33).

According to this structure, the output-side member (14) of the damper (10) is coupled to the inner support member (33) of the first clutch (30). Thus, the damper (10) and the first clutch (30) are coupled together by coupling portions thereof that are located relatively close to each other when the damper (10) and the first clutch (30) are concentric with each other. This facilitates mounting the damper (10) and the first clutch (30) in the manufacture of the vehicle drive device (1), thus simplifying the manufacturing process of the device.

Preferably, the first clutch (30) may be located between the damper (10) and the differential gear device (20) in an axial direction (L) with respect to the damper (10), the first clutch (30) may include a piston (35) for pressing the first friction member (31) and the second friction member (32) from a differential gear device (20) side in the axial direction (L), the outer support member (34) may include a radial extension portion (34a) that is located on the differential gear device (20) side in the axial direction (L) relative to the piston (35) and extends in the radial direction (R), and a cylinder chamber (36) may be formed between the radial extension portion (34a) and the piston (35) in the axial direction (L) to be supplied with oil pressure that is used to drive the piston (35).

This makes it possible to simplify the structure of an oil passage to supply oil to the cylinder chamber (36), compared to when the cylinder chamber (36) is formed between the piston (35) and a member that is located on the opposite side of the piston (35) from the differential gear device (20) in the axial direction (L). Specifically, since parts including an oil passage for lubricating the differential gear device (20) are located on the differential gear device (20) side in the axial direction (L) relative to the first clutch (30), it is common that a hydraulic control device for controlling oil pressure to be supplied to the oil passage is provided on the differential gear device (20) side in the axial direction (L) relative to the first clutch (30). Therefore, forming the cylinder chamber (36) between the piston (35) and the radial extension portion (34a) that is located on the differential gear device (20) side the axial direction (L) relative to the piston (35) reduces the distance between the hydraulic control device and the cylinder chamber (36) and thus simplifies the structure of an oil passage for supplying oil to the cylinder chamber (36), compared to forming the cylinder chamber (36) between the piston (35) and a member that is located on the opposite side of the piston (35) from the differential gear device (20) in the axial direction (L).

Preferably, the damper (10) may be located so as to overlap the first clutch (30) when viewed in the radial direction (R).

This structure reduces the length of a space in the axial direction (L) occupied by three members located in the power transmission path connecting the input member (I) to the differential gear device (20), namely the one-way clutch (40), the damper (10), and the first clutch (30), compared to when the damper (10) is disposed in an area that is different in the axial direction (L) from an area where the first clutch (30) is disposed so as not to overlap the first clutch (30) when viewed in the radial direction (R). Accordingly, the length of the whole device in the axial direction (L) is further reduced.

Preferably, the outer support member (34) may include a plurality of the second friction members (32) arranged in an axial direction (L) with respect to the damper (10), and the damper (10) may include a spring member (11) that is located outside the second friction members (32) in the radial direction (R) so as to overlap the one-way clutch (40) when viewed in the axial direction (L) and that is disposed along a circumferential direction with respect to the damper (10).

According to this structure, the spring member (11) that is included in the damper (10) and that has a relatively large width in the axial direction (L) is located outside the second friction members (32) in the radial direction (R). This allows the damper (10) and the first clutch (30) to be located close to each other in the axial direction (L) without causing interference of the spring member (11) with a group of the plurality of the second friction members (32) that occupies a certain amount of space in the axial direction (L) as a whole, thus making it possible to further reduce the length of the whole device in the axial direction (L). In this case as well, the spring member (11) is located so as to overlap the one-way clutch (40) in the axial direction (L). Therefore, it is possible to reduce a degree of increase in the size of the whole device in the radial direction (R) caused when the spring member (11) is located outside the second friction members (32) in the radial direction (R).

Preferably, the vehicle drive device (1) may include: a first case member (81) that supports the one-way clutch (40); and a second case member (82) attached to the first case member (81), in which the second case member (82) includes a radial wall portion (82a) extending in the radial direction (R), the radial wall portion (82a) has a through hole (83) extending therethrough in an axial direction (L) with respect to the damper (10), the input member (I) is inserted through the through hole (83) and is rotatably supported by the second case member (82) via a bearing (61) that is disposed on an inner peripheral surface of the through hole (83), and the damper (10) and the first clutch (30) are located on a differential gear device (20) side in the axial direction (L) relative to the radial wall portion (82a).

According to this structure, since the second case member (82) that supports the input shaft (I) via the bearing (61) is a separate piece from the first case member (81) that supports the one-way clutch (40), it is possible to attach the second case member (82) to the first case member (81) after each of the damper (10), the first clutch (30), the one-way clutch (40), and the input shaft (I), etc. is mounted to an associated one of the first case member (81) and the second case member (82) in the manufacture of the vehicle drive device (1). This facilitates mounting the components to the case, compared to when the first case member (81) and the second case member (82) are formed as one piece, thus simplifying the manufacturing process of the device.

Preferably, the damper (10) may include a spring member (11) disposed along a circumferential direction with respect to the damper (10), and the spring member (11) is located so as to overlap the one-way clutch (40) when viewed in an axial direction (L) with respect to the damper (10) and so as to overlap the first clutch (30) when viewed in the radial direction (R).

According to this structure, the spring member (11) that is included in the damper (10) and that has a relatively large width in the axial direction (L) is located in a space that is adjacent to the one-way clutch (40) in the axial direction (L) and that overlaps the first clutch (30) when viewed in the radial direction (R) (i.e., a space formed outside the first clutch (30) in the radial direction (R)). This allows the damper (10) to be located close to the first clutch (30) in the axial direction (L) without interfering with the first clutch (30), thus making it possible to further reduce the length of the whole device in the axial direction (L). Another advantage is that since the spring member (11) is located in the space formed outside the first clutch (30) in the radial direction (R), it is easy for the damper (10) to have a diameter necessary to achieve a desired performance in absorbing vibrations.

1-7. (canceled)

8. A vehicle drive device comprising:
an input member drivingly coupled to an internal combustion engine;
an output member drivingly coupled to wheels;
a first rotating electric machine;
a second rotating electric machine drivingly coupled to the output member;
a differential gear device having three rotating elements, namely a first rotating element, a second rotating element, and a third rotating element, in order of rotational speed; and
a friction engagement first clutch that is located in a power transmission path connecting the input member to the differential gear device and that allows the input member and the differential gear device to be decoupled from each other, wherein
the first rotating electric machine is drivingly coupled to the first rotating element,
the input member is drivingly coupled to an input rotating element that is one of the second rotating element and the third rotating element,
the output member is drivingly coupled to an output rotating element that is the other of the second rotating element and the third rotating element,
the first clutch includes an inner support member to which a drive force of the input member is input, and an outer support member that outputs the drive force input to the inner support member and that is coupled to the input rotating element,
at least part of the outer support member is located outside the inner support member in a radial direction with respect to the first clutch,
a positive direction is defined as a rotation direction of the outer support member during transmission of rotation of the input member,
a negative direction is defined as a rotation direction of the outer support member opposite to the positive direction, and
a one-way clutch that allows rotation of the outer support member in the positive direction and that stops rotation of the outer support member in the negative direction is located outside the outer support member in the radial direction so as to overlap the first clutch when viewed in the radial direction.

9. The vehicle drive device according to claim 8, further comprising:
a damper located closer to the input member than the first clutch in the power transmission path and concentric with the first clutch, wherein
the inner support member supports a first friction member from inside in the radial direction,
the outer support member supports, from outside in the radial direction, a second friction member that engages frictionally with the first friction member,
an input-side member of the damper is coupled to the input member, and
an output-side member of the damper is coupled to the inner support member.

10. The vehicle drive device according to claim 9, wherein
the first clutch is located between the damper and the differential gear device in an axial direction with respect to the damper,
the first clutch includes a piston for pressing the first friction member and the second friction member from a differential gear device side in the axial direction,
the outer support member includes a radial extension portion that is located on the differential gear device side in the axial direction relative to the piston and extends in the radial direction, and
a cylinder chamber is formed between the radial extension portion and the piston in the axial direction to be supplied with oil pressure that is used to drive the piston.

11. The vehicle drive device according to claim 10, wherein
the damper is located so as to overlap the first clutch when viewed in the radial direction.

12. The vehicle drive device according to claim 11, wherein
the outer support member supports a plurality of the second friction members arranged in an axial direction with respect to the damper, and
the damper includes a spring member that is located outside the second friction members in the radial direction so as to overlap the one-way clutch when viewed in the axial direction and that is disposed along a circumferential direction with respect to the damper.

13. The vehicle drive device according to claim 12, further comprising:
a first case member that supports the one-way clutch; and
a second case member attached to the first case member, wherein
the second case member includes a radial wall portion extending in the radial direction,
the radial wall portion has a through hole extending therethrough in an axial direction with respect to the damper,
the input member is inserted through the through hole and is rotatably supported by the second case member via a bearing that is disposed on an inner peripheral surface of the through hole, and
the damper and the first clutch are located on a differential gear device side in the axial direction relative to the radial wall portion.

14. The vehicle drive device according to claim 9, wherein
the damper is located so as to overlap the first clutch when viewed in the radial direction.

15. The vehicle drive device according to claim 14, wherein
the outer support member supports a plurality of the second friction members arranged in an axial direction with respect to the damper, and
the damper includes a spring member that is located outside the second friction members in the radial direction so as to overlap the one-way clutch when viewed in the axial direction and that is disposed along a circumferential direction with respect to the damper.

16. The vehicle drive device according to claim 15, further comprising:
a first case member that supports the one-way clutch; and
a second case member attached to the first case member, wherein
the second case member includes a radial wall portion extending in the radial direction,
the radial wall portion has a through hole extending therethrough in an axial direction with respect to the damper,
the input member is inserted through the through hole and is rotatably supported by the second case member via a bearing that is disposed on an inner peripheral surface of the through hole, and
the damper and the first clutch are located on a differential gear device side in the axial direction relative to the radial wall portion.

17. The vehicle drive device according to claim 9, further comprising:
a first case member that supports the one-way clutch; and
a second case member attached to the first case member, wherein
the second case member includes a radial wall portion extending in the radial direction,
the radial wall portion has a through hole extending therethrough in an axial direction with respect to the damper,
the input member is inserted through the through hole and is rotatably supported by the second case member via a bearing that is disposed on an inner peripheral surface of the through hole, and
the damper and the first clutch are located on a differential gear device side in the axial direction relative to the radial wall portion.

18. The vehicle drive device according to claim 17, wherein
the damper includes a spring member disposed along a circumferential direction with respect to the damper, and
the spring member is located so as to overlap the one-way clutch when viewed in an axial direction with respect to the damper and so as to overlap the first clutch when viewed in the radial direction.

19. The vehicle drive device according to claim 9, wherein
the damper includes a spring member disposed along a circumferential direction with respect to the damper, and
the spring member is located so as to overlap the one-way clutch when viewed in an axial direction with respect to the damper and so as to overlap the first clutch when viewed in the radial direction.

20. The vehicle drive device according to claim 10, further comprising:
a first case member that supports the one-way clutch; and
a second case member attached to the first case member, wherein
the second case member includes a radial wall portion extending in the radial direction,
the radial wall portion has a through hole extending therethrough in an axial direction with respect to the damper,
the input member is inserted through the through hole and is rotatably supported by the second case member via a bearing that is disposed on an inner peripheral surface of the through hole, and
the damper and the first clutch are located on a differential gear device side in the axial direction relative to the radial wall portion.

21. The vehicle drive device according to claim 20, wherein
the damper includes a spring member disposed along a circumferential direction with respect to the damper, and
the spring member is located so as to overlap the one-way clutch when viewed in an axial direction with respect to the damper and so as to overlap the first clutch when viewed in the radial direction.

22. The vehicle drive device according to claim 10, wherein
the damper includes a spring member disposed along a circumferential direction with respect to the damper, and
the spring member is located so as to overlap the one-way clutch when viewed in an axial direction with respect to the damper and so as to overlap the first clutch when viewed in the radial direction.

23. The vehicle drive device according to claim 11, further comprising:
a first case member that supports the one-way clutch; and
a second case member attached to the first case member, wherein
the second case member includes a radial wall portion extending in the radial direction,
the radial wall portion has a through hole extending therethrough in an axial direction with respect to the damper,
the input member is inserted through the through hole and is rotatably supported by the second case member via a bearing that is disposed on an inner peripheral surface of the through hole, and
the damper and the first clutch are located on a differential gear device side in the axial direction relative to the radial wall portion.

24. The vehicle drive device according to claim 11, wherein
the damper includes a spring member disposed along a circumferential direction with respect to the damper, and
the spring member is located so as to overlap the one-way clutch when viewed in an axial direction with respect to the damper and so as to overlap the first clutch when viewed in the radial direction.

25. The vehicle drive device according to claim 14, further comprising:
a first case member that supports the one-way clutch; and
a second case member attached to the first case member, wherein
the second case member includes a radial wall portion extending in the radial direction,
the radial wall portion has a through hole extending therethrough in an axial direction with respect to the damper,
the input member is inserted through the through hole and is rotatably supported by the second case member via a bearing that is disposed on an inner peripheral surface of the through hole, and
the damper and the first clutch are located on a differential gear device side in the axial direction relative to the radial wall portion.

26. The vehicle drive device according to claim 25, wherein
the damper includes a spring member disposed along a circumferential direction with respect to the damper, and
the spring member is located so as to overlap the one-way clutch when viewed in an axial direction with respect to the damper and so as to overlap the first clutch when viewed in the radial direction.

27. The vehicle drive device according to claim 14, wherein
the damper includes a spring member disposed along a circumferential direction with respect to the damper, and
the spring member is located so as to overlap the one-way clutch when viewed in an axial direction with respect to the damper and so as to overlap the first clutch when viewed in the radial direction.
